(19) United States
(12) Patent Application Publication
(10) Pub. No.: US 2014/0125130 A1
(43) Pub. Date: May 8, 2014

(54) Power Stealing Thermostat Circuit With Over Current Protection

(71) Applicant: Zhiheng Cao, Aliso Viejo, CA (US)

(72) Inventor: Zhiheng Cao, Aliso Viejo, CA (US)

(73) Assignee: Zhiheng Cao, Aliso Viejo, CA (US)

(21) Appl. No.: 14/156,447

(22) Filed: Jan. 15, 2014

(51) Int. Cl. H02J 3/00

(52) U.S. Cl. CPC H02J 3/00
USPC 307/23

(57) ABSTRACT

A new circuit and associated methods are disclosed for stealing power from HVAC circuit to supply relays and control circuits in an electronic thermostat, and protecting against damage to the relays from over-current condition. If a common connection is available, the circuit can obtain DC power always, if not available, the circuit can still obtain DC power when one of the relays is turned on, and the obtained power can be used to keep turning on the relay, making it possible to use economical and smaller form factor non-latching type relays or solid state relays, without wasting the limited battery charge. Compared with existing power stealing thermostat circuits, the disclosed circuit is advantageous due to its simplicity and no possibility of inadvertently turning on or off the HVAC.

### CROSS-REFERENCE TO RELATED APPLICATIONS

### FEDERALLY SPONSORED RESEARCH

Not applicable

### SEQUENCE LISTING OR PROGRAM

Not applicable

### BACKGROUND OF THE INVENTION

1. Field of the Invention

This invention relates to the control of HVAC systems and/or for other systems for switching on and off one or more AC load. More particularly, embodiments of this invention relate facilitating power stealing or power harvesting in a control device such as a thermostat having a limited battery charge, and protection against circuit damage from short circuit and other over-current conditions.

2. Description of the Related Art

Conventional thermostats are typically battery powered and use mechanical latching relay to connect and disconnect wires labeled “Y”, “W” and/or “G” with “R” which supply 24V AC voltage. The configuration assumed for a thermostat is shown in FIG. 4. Although the relay needs substantial current to turn on, with a mechanical latching relay the current is only needed for a short amount of time during transitioning from off to on state or vice versa.

However, latching relays require two, set and reset coils, and are more bulky and expensive than non-latching type mechanical relays, which only need one coil, or solid state relays (SSR). To maintain non-latching relays and SSRs in conducting state, a substantial current must be flowed constantly. This power consumption due to this current is often much larger than the thermostat control circuit power consumption.

Some thermostat devices have been designed to “steal” power from the voltage potential between the 24VAC power source connection “Rc”, “Rh” or “R” wire and one of the HVAC control wires (load), such as U.S. Pat. No. 8,110,945 and U.S. Pat. No. 5,903,139. FIG. 1 is the simplified circuit diagram of such prior art power stealing thermostats. However, if too much power is consumed by the thermostat control circuit, AC, heat or fan can be inadvertently turned on. U.S. Patent Application US20120199660 describes an elaborate scheme to reduce the possibility this can happen, but still cannot completely eliminate such possibility.

Compared with mechanical relays, SSRs have advantages such as small form factor, silent operation, and high reliability due to no moving parts. However, they are more easily damaged if current higher than the rated current is flowed. Even mechanical relays can be damaged by over-current. Prior art such as U.S. Pat. No. 5,864,458 address this issue by using a combination of PTC type fuse and switches. However, because they are connected in series with the load, there is a trade-off between voltage drop on the fuse and the level of protection. Also, the PTC fuse needs to heat up before the protection mode is triggered, and this process is often too slow to save SSR from damage due to over-current.

### BRIEF SUMMARY OF THE INVENTION

I have discovered in accordance with this invention, a simple yet effective circuit that can be built using readily available components, to generate from the 24VAC power source in HVAC system, very stable 3V DC power to supply thermostat control circuits and relays, without substantially affecting the functionality of the HVAC system and without the possibility of inadvertently turning on or off the HVAC functions, and at the same time, providing over current protection function that is much faster acting than PTC fuses, to allow protection of SSRs and other circuit components from damage due to over current.

According to the preferred embodiment shown in FIG. 2a, a circuit is described that controls a PNP bipolar junction transistor (BJT) Q1 based on a feedback circuit that detects the positive voltage drop across the collector-emitter of Q1, and controls the base of Q1 such that the voltage drop is no higher than a desired DC voltage, such as 3V. This circuit is connected in series with AC relays that turns on or off HVAC functions. When higher than the desired voltage is applied, the base of Q1 is pulled down by the feedback circuit such that Q1 becomes conducting enough to allow the extra voltage to be passed to the AC load to turn on HVAC function. The feedback circuit itself is also connected in parallel with the BJT and in series with the AC load. Such feedback circuit is readily available at low cost, preferably implemented as part number TLVH431 from Texas Instruments. By the parasitic diode internal to the BJT Q1, the circuit will conduct current when collect-emitter voltage is negative, but a second shunt diode D1 can be added if the parasitic diode has unspecified characteristics. As a result, the collector-emitter voltage of Q1 will be exactly 3V during the positive half cycle of the 24V AC, and ˜0V during the negative half cycle.

A diode and a large capacitor generate a stable DC supply from the half-wave rectified collector-emitter voltage of Q1. The feedback circuit allows stable voltage to be generated regardless of how much current is consumed by the AC load.

Because the thermostat typically uses 24VAC (rms) or above, the AC load originally sees voltage swinging from approximately +34V to −34V, and with the proposed circuit, the AC loads still see voltage swinging from approximately +31V to −34V, i.e. 95% or more of the original voltage swing, allowing proper functionality of the AC loads to be retained.

Unlike other power stealing thermostats, there is no possibility of false switching because if the power stealing circuit uses too much power, it will only make the AC loads see higher (than 95%) voltage swing, making it more reliable to turn on/off HVAC functions, until diode D3 turns on and the thermostat control circuit and the relays receive supplemental power from battery 109.

The insertion of the BJT Q1 not only allows power stealing, but also allows it to function in place of a current sensing resistor that must be placed in series with the load to detect over-current in other over current protection schemes, such as U.S. Pat. No. 8,035,938. This is done by adding a scaled down PNP BJT Q2 with similar temperature characteristics as Q1, and connecting their base and emitter to form a current mirror. The collector current in Q2 will then be proportional to the load current, with a constant, substantially temperature independent scaling factor. This current is flowed through resistor R4 to generate voltage drop in the 3V DC domain which supplies microprocessor 103 and comparator 102 with low propagation delay. If the voltage on R4 rises above a threshold, a microprocessor interrupt is generated by the comparator 102 and the interrupt routine in the microprocessor 103 turns off all relays 104˜106 to break the circuit. Because no additional current sensing resistor is needed, not only will there be more voltage to be applied to AC load, but also no need to design additional heat sink element for such current sensing resistor.

### BRIEF DESCRIPTION OF THE SEVERAL VIEWS OF THE DRAWING

In the accompanying drawings:

FIG. 1 is a view showing the configuration of a power stealing thermostat circuit in the related art;

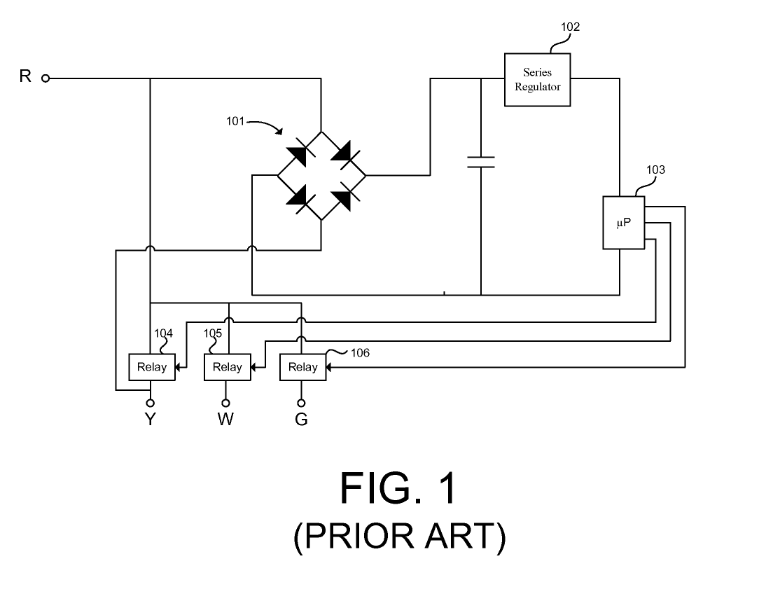

FIG. 2a is a view showing the configuration of a power stealing thermostat circuit with over-current protection circuit according to a preferred embodiment of the present invention;

FIG. 2b is a view showing the configuration of a power stealing thermostat circuit according to a second embodiment of the present invention;

FIG. 2c is a view showing the configuration of a power stealing thermostat circuit according to a third embodiment of the present invention;

FIG. 3 is a graph of waveforms illustrating the operation of the invention; and

FIG. 4 is a view showing the assumed external connections of thermostat circuit shown in FIGS. 1, 2a, and 2b.

### DETAILED DESCRIPTION OF THE EMBODIMENTS

Embodiments of active current surge limiters are described below. It should be emphasized that the described embodiments are merely possible examples of implementations, and are set forth for clear understanding of the principles of the present disclosure, and in no way limit the scope of the disclosure.

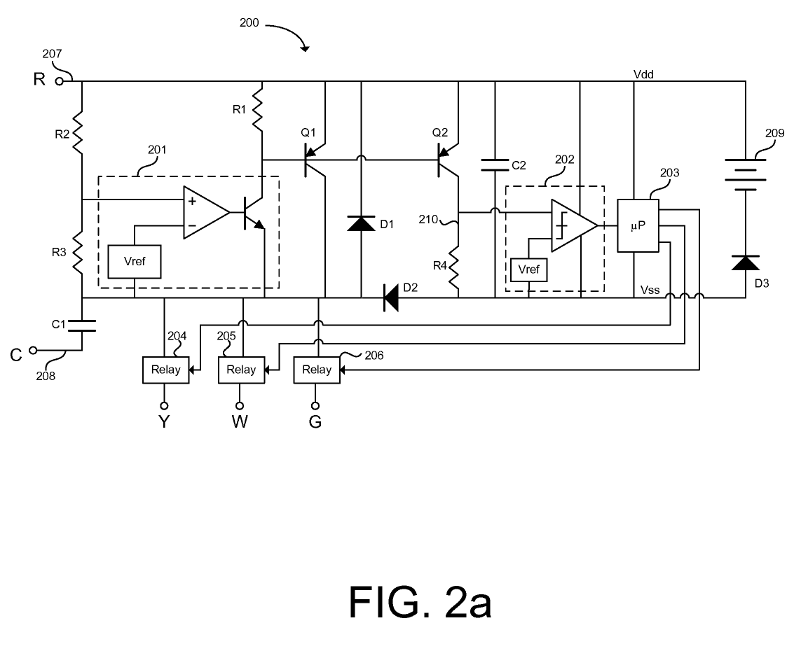

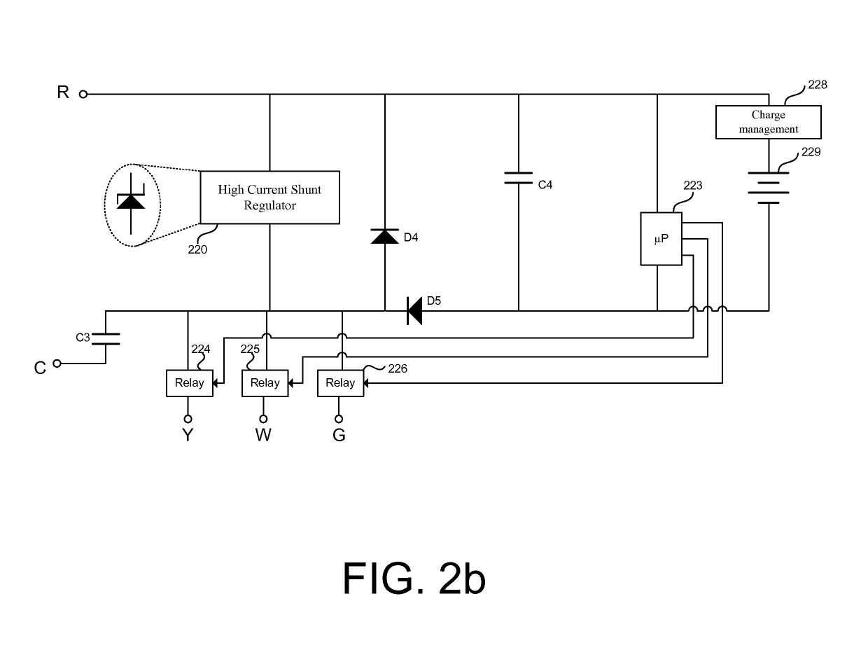

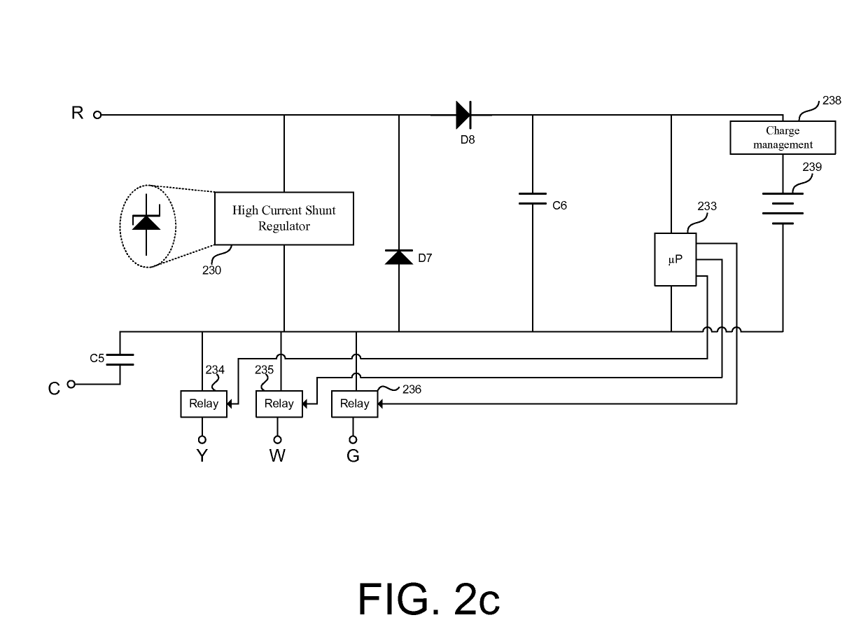

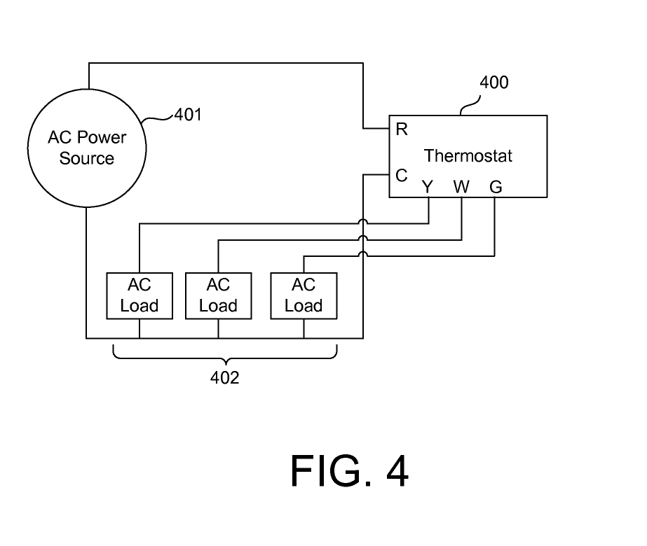

The preferred embodiment of the invention is shown in FIG. 2a, which shows an internal configuration of a thermostat 400 in FIG. 4 with basic function to turn on heat, AC and fan by connecting the AC power source 401 with AC loads 402 using solid state relays. Terminal 207 corresponds to either terminal “R”, “Rc” or “Rh” in a conventional thermostat and is typically connected to one end of a 24V AC power source. Terminal 208 corresponds to terminal “C” in a conventional thermostat and is connected to the opposite end of the 24V AC power source.

A high voltage, high wattage bipolar junction transistor Q1, preferably DXT2014P5 from Diodes Inc., is connected among terminal R, one end of relays 204˜206 and output terminal of 201 as shown. The wattage of Q1 is determined by the desired DC voltage to be generated (3V in this embodiment) times the maximum possible AC current from terminal R, times half. A heat sink may have to be attached to Q1. In place for bipolar junction transistor for Q1, an equivalent field effect transistor may also be used.

Voltage reference and feedback circuit 201, preferably implemented using part number TLVH431 from Texas Instruments, is powered by bias current generated by R1. The value of R1 should be chosen small enough to supply 201 as well as the base current of BJT Q1. The output terminal of 201 is connected to the base terminal of Q1. The resistor divider formed by R2 and R3 generates a feedback voltage and is connected to the input terminal of 201, such that desired collector-emitter voltage of Q1*R3/(R2+R3)=reference voltage in 201. The size of R2 and R3 is determined by the reference input current requirement of circuit 201. The ground terminal of 201 is connected to the collector terminal of Q1.

Solid state relays 204˜206 are connected between collector terminal of Q1 and each type of AC loads 402. The control terminals of 204˜206 are connected to microprocessor 203, such that firmware program running in 203 can turn on and off each of the relay 204˜206.

The diode D1 is connected between collector and emitter of Q1 and may be omitted because the Q1 inherently includes this diode, in the form of what is called “body diode” of the transistor; but is beneficial to be included to allow more AC voltage to be applied to the AC load.

The diode D2, preferably RB056L-40TE25 from Rohm Semiconductor, is connected between collector of Q1 and Vss of the microprocessor. D2 should be chosen to have much lower reverse leakage current than the sleep current of the microcontroller 203, such that when HVAC is not turned on, the leakage will not degrade the battery life. At the same time, D2 should have low forward voltage drop such that the collector-emitter voltage of Q1 can be chosen as small as possible.

A large, preferably 220 uF capacitor C2 is connected between Vdd and Vss of the microprocessor 203. The size of this capacitor is determined by the current requirement of the microprocessor 203 and other circuits that use the generated DC supply, such as comparator 202, radio transceivers, and the relays 204˜206.

A second PNP BJT Q2, preferably BC857B from NXP Semiconductor, is connected as shown in the figure with base and emitter terminals tied to the base and emitter terminals of Q1, respectively. The nominal current of Q2 is chosen to be smaller than Q1 and they have similar temperature characteristics, such that when both are in linear region, their collector currents are related with a fixed, temperature independent radio.

A low power comparator and a reference 202, preferably MIC842HYC5 from Micrel Inc., is connected between Vdd and Vss. The input of 202 is connected to net 210. The output of 202 is full swing digital signal, and is connected to the interrupt input of 203.

The collector of Q2 is connected to resistor R4. The other end of R4 is shared with the Vss of the comparator reference. The value of R4 is chosen such that the voltage on 210 exceeding the comparator reference voltage indicates the collector current of Q1 exceeding the rated current of any of the relay 204˜206.

The microcontroller 203 contains a firmware program that enables the interrupt, and includes an interrupt service routine (ISR) that is run whenever the comparator output indicates over current condition. The ISR turns off all relays 204˜206, and then notify user of the over-current condition through LED, sound, or through wireless signals.

A capacitor C1 is connected between the collector of Q1 and common terminal 208, typically labeled “C”. When terminal 208 is connected, current flows through C1 and Q1, allowing the circuit to generate stable 3V DC supply without wasting much power because the voltage and current in C1 are substantially out of phase. C1 is chosen to sustain at least 34V voltage and with 24VAC applied, allowing sufficient current to flow to maintain 3V on the capacitor C2. The preferred size of C1 is found to be 10 uF to 15 uF in this preferred embodiment.

A second embodiment of the invention is shown in FIG. 2b. A high current shunt regulator 220, which can be implemented using a variety of methods including Zener diode and feedback circuit similar to those in TL431 from Texas Instruments, is connected between terminal R and one end of relays 224˜226. The shunt regulator 220 tries to maintain the voltage across it at a fixed value, for example 3V, by adjusting its impedance. As a result, if terminal C is connected, or any of the relays 224˜226 is turned on and corresponding terminal is connected, current will flow from R, and during the positive half cycle, 3V appears across 220 and during the negative half cycle 0V appears across 220 because of D4. D5 and C4 generates a DC voltage from this waveform to supply microprocessor 223 which in turn supplies relays 224˜226. When there is not enough current flowing from terminal R, 228 starts to conduct, and battery 229 provides supplemental DC power. Otherwise, 238 may use the generated power to charge battery 239. When terminal C is connected, the capacitor C3 allows enough current to flow from terminal R to supply microprocessor 223 and indirectly relays 224˜226.

A third embodiment of the invention is shown in FIG. 2c. Everything is similar to the second embodiment except that the generated DC supply shares a different terminal with the AC power source. This configuration is sometimes necessary if the relays 234˜236 are not electrically isolated. However, to implement the over-current protection, along with NPN power transistors, Vdd referenced voltage references are needed, and these components are not as commonly available as their Vss referenced counterparts.

A high current shunt regulator 230, which can be implemented using a variety of methods including Zener diode and feedback circuit similar to those in TL431 from Texas Instruments, is connected between terminal R and one end of relays 234˜236. The shunt regulator 230 tries to maintain the voltage across it at a fixed value, for example 3V, by adjusting its impedance. As a result, if terminal C is connected, or any of the relays 234˜236 is turned on and corresponding terminal is connected, current will flow from R, and during the positive half cycle, 3V appears across 230 and during the negative half cycle 0V appears across 230 because of D7. D8 and C6 generates a DC voltage from this waveform to supply microprocessor 233 which in turn supplies relays 234˜236. When there is not enough current flowing from terminal R, 238 starts to conduct, and battery 239 provides supplemental DC power. Otherwise, 238 may use the generated power to charge battery 239. When terminal C is connected, the capacitor C5 allows enough current to flow from terminal R to supply microprocessor 233 and indirectly relays 234˜236.

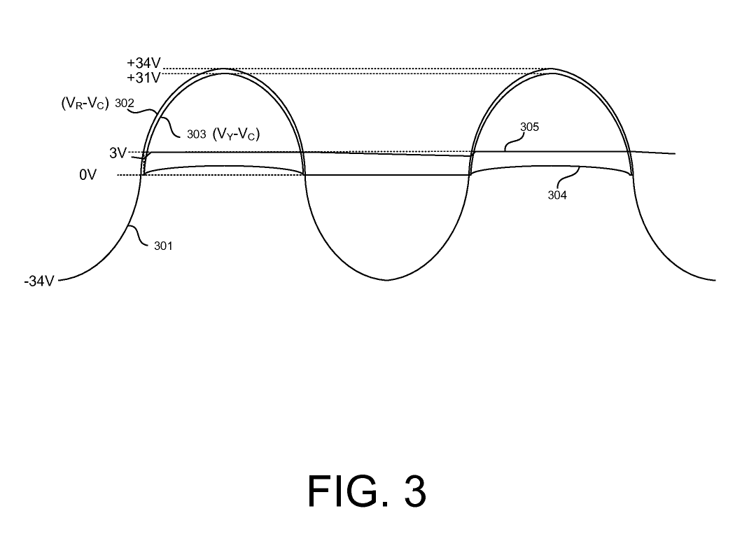

For purposes of explaining the operation of the invention as embodied in the FIG. 2a circuit, FIG. 3 shows voltages at various points for two cycles of the AC waveform present between terminals “R” and “C”. For purposes of explaining the invention, the waveform is not drawn to scale, but the voltage levels are marked. Each diode D1 and D2 is assumed to be ideal, i.e. with zero forward bias voltage and zero reverse leakage current. Terminals R and C are assumed to be connected to a 24V RMS sine wave AC power source, which is typically used by HVAC systems, so the peak AC voltage is approximated +/−34V. Relay 204 is presumed to be turned on (conducting) with zero impedance. 301 is the waveform of terminal R and Y, measured against terminal C, during the negative half cycle of the AC power source. 302 is the waveform of terminal R measured against terminal C during the positive half cycle, and 303 is the waveform of terminal Y measured against terminal C during the positive half cycle. Because the voltage drop on Q1 is 3V only during the majority of positive half cycle, Y terminal swings from −34V to +31V, while R terminal swings from −34V to +34V. Therefore, the Y terminal receives higher than 95% of the voltage available from the source, allowing it to control HVAC function properly. 305 is the waveform on net “Vdd” measured against net “Vss”. During the positive half cycle, D2 conducts making it 3V. During the negative half cycle, D2 is reverse biased, and the capacitor C2 provides charge, and this waveform will see slight droop until the next positive cycle. 304 is the waveform on net 210 measured against net “Vss”. The peak voltage of 304 is substantially proportional to the peak current flowing through the relay 204 because when 304 reaches near its peak, both Q1 and Q2 are in the linear operation region and forms a current mirror, and since the total current flowing through R2, R3, 201, D1, C2, 202, 203 and 209 is negligibly small compared with the current flowing in Q1 and the relay 204. Therefore, comparator 202 can detect over-current condition by comparing waveform 304 against a fixed reference voltage.

I claim:

1. A power stealing AC load switching circuit that generates from a relatively high voltage AC power, a relatively low voltage DC power for use by a control circuit to turn on at least one AC switch to supply power to at least one AC load, comprising:
at least one AC switch which is connected in series with a shunt regulator, one terminal of the shunt regulator is connected to one rail of the generated DC power;
a first diode which is connected in parallel with the shunt regulator;
a second diode which is connected between the other terminal of the shunt regulator and the other rail of the generated DC power;
a first capacitive element which is connected between the two rails of the generated DC power;
a battery and charge management unit which are connected to the generated DC power so as to provide supplementary power to prevent the DC power to collapse below a certain voltage when there is not enough AC power; and
a microprocessor which is supplied by the two rails of the generated DC power and is coupled to the AC switch for turning the AC switch on and off.

2. The circuit of claim 1, wherein the shunt regulator is a Zener diode.

3. The circuit of claim 1, wherein the shunt regulator comprises a first power transistor which are connected between the two terminal of the shunt regulator, a smaller shunt regulator whose output is coupled to the control terminal of the power transistor, and a voltage divider circuit to generate feedback input to the smaller shunt regulator.

4. The circuit of claim 1, further comprising: a second capacitive element connected between one terminal of the shunt regulator and one terminal of an external AC power source.

5. The circuit of claim 3, further comprising:
a second transistor whose control terminals are connected to the corresponding control terminals of the first power transistor;
a resistive element that is coupled to the second transistor and to one rail of the generated DC power;
and a comparator circuit whose input is coupled to the resistive element, and whose output is coupled to the microprocessor.

6. A method of generating a relatively low voltage DC power for use by a control circuit to turn on at least one AC switch to supply power from a relatively high voltage AC power source to at least one AC load, comprising the steps of:
connecting a shunt regulator comprising a pass semiconductor device, in series with the AC switch to generate a fixed voltage during one half cycle of the AC power source;
connecting a first diode in parallel with the shunt regulator to allow substantially the entire voltage of the AC power source to be applied to the AC load during the other half cycle of the AC power source;
connecting a second diode between the one terminal of the shunt regulator and the one rail of the generated DC power;
connecting a capacitive element between the rails of generated DC power;
connecting a battery and its charge management unit to the generated DC power to supplement the generated DC power, and
supplying a microcontroller using the generated DC power which in turn controls and provide turning on power to the AC switch.

7. A method in accordance with claim 6 and comprising the additional step of
forming a current mirror with the pass semiconductor device to extract a small current signal that is proportional to the amount of current flowing in the pass semiconductor device.

8. A method in accordance with claim 7 and comprising the additional steps of
comparing the small current signal with a reference level, and if the small current signal exceeds the reference level, triggers an interrupt to the microcontroller.

9. A method in accordance with claim 8 and comprising the additional steps of
upon receiving the interrupt indicating the small current signal exceeded the reference level, turning off at least one of the AC switch.
